(19) United States
(12) Patent Application Publication
(10) Pub. No.: US 2023/0071907 A1
(43) Pub. Date: Mar. 9, 2023

(54) COMPONENT HAVING AN INTERMEDIATE SPACE WITH CHANGEABLE OPTICAL TRANSPARENCY

(71) Applicants: Ziya DEMIRCAN, Konz (DE); Fatih Kürsad DEMIRCAN, Konz (DE); Erdinc Muhammed DEMIRCAN, Konz (DE)

(72) Inventors: Ziya DEMIRCAN, Konz (DE); Fatih Kürsad DEMIRCAN, Konz (DE); Erdinc Muhammed DEMIRCAN, Konz (DE)

(21) Appl. No.: 17/794,158

(22) PCT Filed: Feb. 1, 2021
(86) PCT No.: PCT/DE2021/100090

§ 371 Date: Jul. 20, 2022

(30) Foreign Application Priority Data
Jan. 31, 2020 (LU) LU101623

(51) Int. Cl. E06B 9/24; G02B 26/00; E06B 3/67

(52) U.S. Cl. CPC E06B 9/24; G02B 26/004; E06B 3/6722; E06B 2009/2411; E06B 2009/2417; E06B 2009/2405; E06B 2009/247

(57) ABSTRACT

A component having a first, optically transparent pane and a second optically transparent pane, the first pane and the second pane being spaced apart from one another at least in some areas by means of a space. The component further comprises a separating device which divides the space into a first space area and a second space area; an introduction device for introducing fog, e.g., a colored gas, or a colored liquid that changes the passage of light at least through the first space area, at least in the first space area; and a means for removing the fog, the liquid or the gas at least from the first space area. In addition, the component further comprises an illuminating device for illuminating at least the interior of the first space area and/or the separating device is movable.

### CROSS-REFERENCE TO RELATED APPLICATIONS

The present invention is the US national stage under 35 U.S.C. § 371 of International Application No. PCT/DE2021/100090 which was filed on Feb. 1, 2021, and which claims the priority of application LU 101623 filed on Jan. 31, 2020 the contents of which (text, drawings and claims) are incorporated here by reference in their entirety.

### FIELD

The invention relates to a component such as a window, a door, a conservatory element, a balcony glazing or another partition with a pane space with changeable optical transparency, in particular for use as a privacy screen element or for the provision of sight protection.

### BACKGROUND

From DE 698 262 a method and a device for the darkening of light surfaces in buildings is known. For this purpose, the space between two glass panes is filled with a fog or a gas so that light from inside the building can no longer escape to the outside. The fog or gas is located in an external storage container and, if necessary, is pumped into the space or extracted from there again.

Similar proposals are also known from DE 10 2006 009 620 A1, DE 202 11 924 U1, DE 22 49 543 A1 and EP 0 402 529 A1.

From FR 2 599 781, a device is known wherein a colored fluid such as a colored gas is introduced into a space, which may have technical or aesthetic purposes. A selective change in the color of the light passing between the glass panes is also known from U.S. Pat. No. 4,044,519. Colored liquids are used there. Similar approaches are known from EP 2 279 320, U.S. Pat. Nos. 2,378,591, 2,062,747, and DE GM 76 10 287, as well as from DE 10 2006 009 620 A1, DE 202 11 924 U1, DE 22 49 543 A1 and EP 0 402 529 A1.

In U.S. Pat. Nos. 2,489,751 and 2,373,214, the passage of light through a transparent roof of a vehicle is changed by introducing a liquid or fluid into a space between two glass panes.

FR 613 587 describes a headlight of a car that has two panes with a space between them, wherein the space can be temporarily filled with a colored fluid from a reservoir in order to dim the headlight.

### SUMMARY

In a first exemplary embodiment of the invention, a component is disclosed having a first, optically transparent pane and a second pane, in particular a second optically transparent pane, wherein the first pane and the second pane are spaced apart from one another at least in some areas by means of a space; a separating device dividing the space into a first space area and a second space area; an introduction device for introducing fog, an in particular colored gas for changing the passage of light at least through the first space area, or an in particular colored liquid for changing the passage of light at least through the first space area; and a means for removing the fog, liquid, or gas at least from the first space area; wherein the separating device is movable and the separating device separates the first space area from the second space area in one of an at least substantially gas-tight, liquid-tight, or fog-tight manner, in particular by means of one or more seals.

In a second exemplary embodiment of the invention, a component is disclosed having a first, optically transparent pane and a second pane, in particular a second optically transparent pane, wherein the first pane and the second pane are spaced apart from one another at least in some areas by means of a space; a separating device dividing the space into a first space area and a second space area; an introduction device for introducing fog, an in particular colored gas for changing the passage of light at least through the first space area, or an in particular colored liquid for changing the passage of light at least through the first space area; and a means for removing the fog, liquid, or gas at least from the first space area; wherein the separating device is movable, in particular horizontally or vertically movable, within the space so that by a movement of the separating device the size of the first space area can be changed or the ratio of the size of the first space area to the size of the second space area can be changed, and wherein the separating device is formed in the form of a rod or beam or as a hollow element.

In a third embodiment of the invention, a component is disclosed having a first, optically transparent pane and a second pane, in particular a second optically transparent pane, wherein the first pane and the second pane are spaced apart from one another at least in some areas by means of a space; a separating device dividing the space into a first space area and a second space area; an introduction device for introducing fog, an in particular colored gas for changing the passage of light at least through the first space area, or an in particular colored liquid for changing the passage of light at least through the first space area; and a means for removing the fog, liquid, or gas at least from the first space area; wherein the component has a lighting device for illuminating at least the interior of the first space area and/or the separating device is movable; a generating device is provided for the generation of the fog or gas and/or a storage device is provided for storing the fog, liquid or gas; and the generating device is arranged within the space or within the first space area or it is part of the separation device or integrated into it, and/or the storage device is arranged within the space or within the first space area or it is part of the separation device or integrated in it.

In a fourth embodiment of the invention, a component is disclosed having a first, optically transparent pane and a second pane, in particular a second optically transparent pane, wherein the first pane and the second pane are spaced apart from one another at least in some areas by means of a space; a separating device dividing the space into a first space area and a second space area; an introduction device for introducing fog, an in particular colored gas for changing the passage of light at least through the first space area, or an in particular colored liquid for changing the passage of light at least through the first space area; and a means for removing the fog, liquid, or gas at least from the first space area; wherein the component has a lighting device for illuminating at least the interior of the first space area and/or the separating device is movable; and wherein further a control device is provided for automatic regulation or manual control of the optical transparency of at least a portion of the component to a desired or preset level.

In an exemplary embodiment of the invention, the component has a first, optically transparent pane and a second, optically transparent pane. In various instances, both panes are glass panes or plexiglass panes.

In an exemplary embodiment of the invention, the component has a first, optically transparent pane and a second, optically transparent pane. The component further has a lighting device for illuminating at least the interior of a first space area.

In an exemplary embodiment of the invention, the component has a first, optically transparent pane and a second, optically transparent pane. The component further has a lighting device for illuminating at least the interior of a first space area and has a separating device which is designed to be movable.

In an exemplary embodiment of the invention, the separating device is arranged to be horizontally or vertically movable within the space, so that by a movement of the separating device the size of the first space area or the ratio of the size of the first space area to the size of a second space area can be changed.

In an exemplary embodiment of the invention, the lighting device has one or more LEDs, one or more lasers or other means for illuminating at least the interior of the first space area. It is particularly preferred when there are one or more light strips or light guides provided surrounding at least the first space area.

In one exemplary embodiment of the invention, wherein the component further comprises a suction device arranged outside the space or the first space area and in various instances also outside the component and is connected to the first space area via a line.

In another exemplary embodiment of the invention, wherein the suction device is arranged within the space or within the first space area or is part of the separating device or integrated into it.

In an exemplary embodiment of the invention, the first pane and in various instances also the second pane and, if present, and at least one further pane is formed of glass, plexiglass or another transparent or glass-like material.

In an exemplary embodiment of the invention, the component further comprises a means to make the space accessible, in particular for maintenance or cleaning purposes, and/or to allow the first pane to be moved, opened or removed.

In an exemplary embodiment of the invention, the component further comprises a sensor system which measures the passage of light through the first space area between the first and the second pane and, depending on a desired or preset level of transparency, controls or regulates via the control device the quantity, the location of the supply and/or the density of the fog or fluid supplied or discharged.

In an exemplary embodiment of the invention, the control or regulation is set up wirelessly, in particular via a WLAN, and by means of software, in particular an app.

In one exemplary embodiment of the invention, the component further comprises: a generating device for the generation of the fog or the gas; and/or a storage device for storing the fog, liquid, or gas.

In one exemplary embodiment of the invention, the generating device is arranged outside the space or the first space area and in various instances also outside the component, and/or the storage device is arranged outside the space or the first space area and in various instances also outside the component.

In another exemplary embodiment, the generating device is arranged within the space or within the first space area or it is part of the separating device or integrated into it, and/or the storage device is arranged within the space or within the first space area or that it is part of the separating device or integrated into it.

In an exemplary embodiment of the invention, the separating device separates the first space area from the second space area in a gas-tight, liquid-tight, or fog-tight manner, in particular by means of one or more seals.

In an exemplary embodiment of the invention, the separation device is formed in the form of a rod or beam or as a hollow element.

In an exemplary embodiment of the invention, the component includes at least one further pane, in particular at least one further optically transparent pane is provided, which is spaced apart from the second pane at least in some areas by a further space.

In one exemplary embodiment, the means for removing the fog, the liquid or the gas is provided in the form of a suction device.

In various embodiments, the component can be a window or a glazing element of a window or a conservatory. Alternatively, in various embodiments, the component can be a door, in particular a glass door, or a glazing element of a door. Furthermore, in various embodiments, the component can be a room divider or a partition wall or part of a room divider or a partition wall. Finally, in various embodiments, the component can be a shower cubicle or part of a shower cubicle, an aquarium or part of an aquarium, or it can be a glazing element of a balcony balustrade or part of a balcony boundary or a light dome.

Using the component according to the invention, a privacy screen can be achieved in a flexible and effective way, especially in or at buildings (windows, doors, light domes, shower cubicles, aquariums, balcony glazing, conservatories, room dividers, office glazing, . . . ), which can be “switched on” as required and lifted again as required. Due to the movable separating device, the view protected area can be changed as required. On the one hand, the lighting can serve aesthetic purposes or lighting purposes, but above all it enhances the privacy screen effect.

The separating device can be present also several times, and there can correspondingly be several such movable separation devices provided. In this way, for example, the light passage can be changed only in a part of the space or the light passage in different spaces can be changed in different ways.

The separating device can advantageously also be used for lighting purposes or can be part of the lighting device. For this purpose, it is formed, for example, as a hollow element, and in the hollow element, for example, LEDs are arranged. In this embodiment, the hollow element is at least partially made of glass or plexiglass, for example.

### DRAWINGS

FIG. 1 exemplarily shows a top view from the front of a component in the form of a window, in accordance with various embodiments of the invention.

FIG. 2 exemplarily shows a sectional view of the component in FIG. 1 along the section line shown in FIG. 1, in accordance with various embodiments of the invention.

FIG. 3 exemplarily shows a sectional view analogous to FIG. 2 of an alternative embodiment of the component in the form of a window.

FIG. 4 exemplarily shows a top view from the front of alternative embodiment of the component wherein the component is in the form of a window.

### DETAILED DESCRIPTION

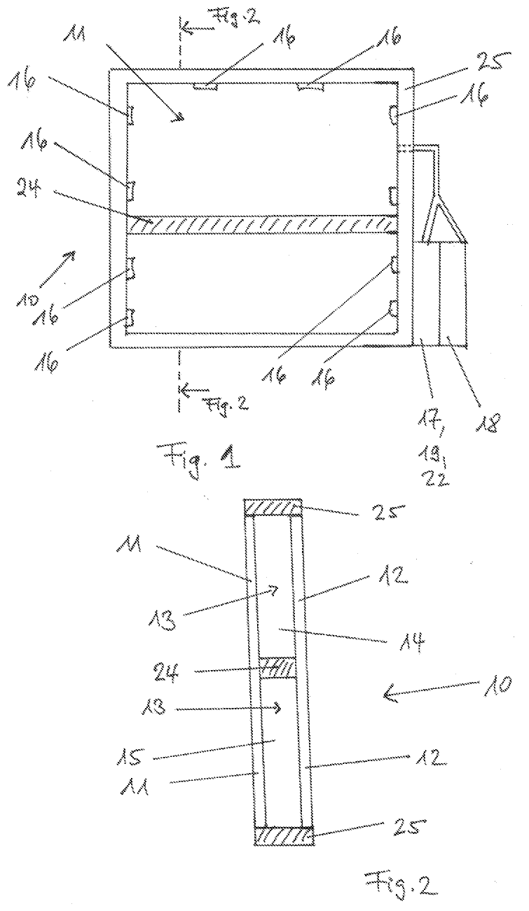

FIG. 1 shows a top view from the front of a component 10 in the form of a window with a frame profile 25, in which a first glass pane 11 and a second glass pane 12 is inserted. Between the panes 11, 12 is a space 13, which is divided by means of, in various instances, an upwards and downwards movable separating device 24 into a first space area 14 and a second space area 15. Area-wise or circumferentially in the area of the frame profile 25, one or more lighting devices 16 such as LEDs or light bands are attached, which illuminate the interior of the first space area 14 and, in various instances, also the interior of the second space area 15. Furthermore, the component comprises an introduction device 17 for introducing fog or colored gas into the first space area 14 is provided, as well as a generating device 19 for the fog or the gas. This generating device 19 can be a fog machine, as it is known as such in the field of event technology. The introduction device 17 is, for example, a pump that is connected via a line through the frame profile 25 to the space 13. The introduction device 17 introduces the fog or the gas or alternatively another fluid such as a colored liquid into the first space area 14, so that the optical transparency there changes and the first space area 14, in various instances, becomes at least largely opaque. For the removal of the fog, gas or liquid, the component comprises a removal means 18, for example, a suction device. The introduction device 17 and the removal means 18 can be integrated in a common component. They can be arranged away from the frame profile 25 and connected to it via lines, but they can also be integrated in the frame profile 25 or in the separating device 24, which then has suitable introduction openings or suction openings. Furthermore, valves and seals are provided as required. The removal means 18 can also be arranged or connected in the lower area of the frame profile 25 and there be connected to the space 13 via an opening in the frame profile 25.

The generating device 19 can be combined with a storage device 22 for fog, gas or liquid. Alternatively, the generating device 19 can also be dispensed with and only a storage device 22 in the form of a tank or reservoir can be provided, which can be refilled if necessary. The introduction device 17 can also be simply designed as a pressurized container. The removal means 18 for removing the fog, gas or liquid can finally also be a simple drain valve or a drain or a drain opening, in particular in the lower area of the frame profile 25.

FIG. 2 shows a section through FIG. 1 along the section line shown in FIG. 1. One can also see here the second pane 12 as well as the frame profile 25 and the separating device 24 in sectional view.

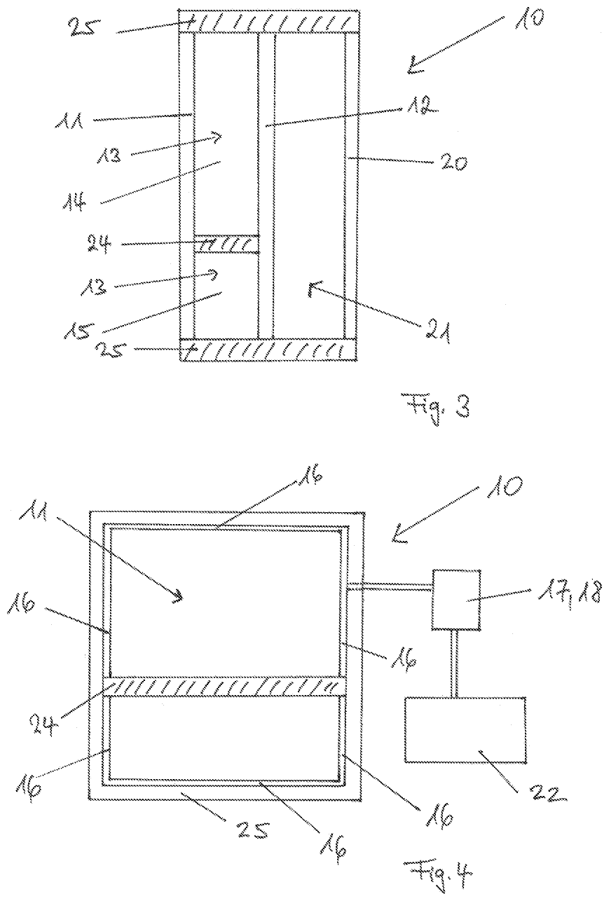

FIG. 3 shows a section analogous to FIG. 2 through the component 10 in the form of a window in an exemplary alternative embodiment. In contrast to FIG. 1 or 2, the component 10 now also further includes a glass pane 20, which is in various instances connected or manufactured with the second glass pane 12 and the frame profile 25 as with commercially available double-glazed windows. The further pane 20 and the second pane 12 thus form a further space 21, which is formed like in commercially available double-glazed windows, i.e., in particular contains a vacuum or a heat-insulating gas. Of course, further panes and corresponding spaces can be provided (not shown), as is known with triple-glazed windows.

FIG. 4 shows a top view from the front of another alternative exemplary embodiment of the component 10 in the form of a window, wherein this time, in contrast to FIG. 1, no generating device 19 is provided but only a storage device 22 in form of a tank or reservoir. Furthermore, the introduction device 17 and the removal means for 18 are integrated in a single component in FIG. 4. This component can be a pump that can be switched between pumping into the space 13 and sucking out of the space 13. If the fluid contained in the storage device 22 is under pressure, it can also be sufficient to form the introduction device 17 as an inlet valve and the removal means 18 as an exhaust valve or to form both as a switchable inlet/outlet valve. In FIG. 4, the lighting device 16 is formed as a circumferential light strip.

The separating device 24 is, in various instances, movably designed, as is known in the case of blinds or roller shutters mounted inside multi-glazed windowpanes. The separating device 24 can be moved horizontally when arranged horizontally or vertically when arranged vertically, so that the space occupied by the fog or fluid increases or decreases. For this purpose, a corresponding adjustment device as it is known, for example, from roller shutter or blind drives, is provided, which can be mechanically or electrically driven.

The separating device 24 is, in various instances, provided with sealing devices such as sealing lips to separate the first space area 14 from the second space area 15 in a fluid-tight way, so that no or substantially no fog, gas or fluid passes over in an undesired manner from the first space area 14 to the second space area 15. The separating device 24 is, for example, formed as a movable hollow element, in various instances as a hollow round tube or rod, or as a movable, in various instances hollow beam. In this case, the generating device 19 and/or the storage device 22 and/or the removal means 18 can also be arranged inside the hollow element, wherein this element then in various instances has one or more openings to the first space area 14 through which the fluid or the fog can be introduced into the first space area 14 and can be removed from there again.

Overall, the component 10 is in various instances designed such that the first space area 14 filled with fog, gas or liquid is opaque or at least substantially opaque, so that the component 10 can be used as a privacy screen, darkening or dimming.

When using a fog, a colored gas, or a colored liquid, the component 10 can also be used for the aesthetic design of rooms, cabins, demarcated areas, balconies, windows, doors, etc.

Suitable fogs, gases or liquids and the corresponding generating devices are known, for example, from the field of event technology, where they are used, among other things, for show effects in music performances and in discotheques. The materials used there can also be used in the context of the present invention. The same applies to fog, gas or liquid generating devices and to corresponding storage devices such as tanks or reservoirs.

In an exemplary embodiment, the used fog or gas is white.

Due to the movably designed separating device 24, the first space area 14 can thus be specifically enlarged or reduced, so that a control of the area protected for example against view can be carried out.

As lighting device 16, commercially available light strips, chains of lights, laser arrangements, LEDs, incandescent lamps, etc. come into consideration, which are arranged, for example, in certain areas or circumferentially around the first space area 14 and illuminate its interior. By combining the lighting with the fog, colored gas or the colored liquid in it, aesthetically beautiful lighting effects, moving images or light surfaces can be created. In addition, the component 10 with the lighting device 16 can thus also serve to illuminate a room. The lighting in combination with the fog or colored gas or fluid causes an increase in the privacy through the fog or the fluid, as is known to every driver when driving in heavy fog and with bright lighting or when exposed to a bright light of oncoming traffic. The lighting and the fog or the gas create a light reflection that further reduces the optical transparency of the first space area 14 for the viewer and thus improves the privacy screen effect.

For maintenance and cleaning purposes, the component 10 is in various instances designed in such a way that the first pane 11 can be opened or the space 13 can be made accessible.

To control the optical transparency of the component 10 to a desired or preset level, a sensor system (e.g., a photo cell or a stray light detector with associated electronics) can be provided, which measures the light passage through the first space area 14 between the first and the second pane 11, 12 and correspondingly, depending on the desired degree of transparency, controls via a control device in various instances wired or wireless (e.g., via a WLAN) the quantity, the location of supply and/or the density of the supplied or discharged fog or fluid.

The control or regulation of the optical transparency of the component 10 to a desired or preset level can alternatively also be carried out purely manually wired or wirelessly (e.g., via a WLAN) via a control device with which, according to the desired degree of transparency, the quantity, the location of supply and/or the density of the supplied or discharged fog or fluid is changed.

In an exemplary embodiment of the invention, the control or regulation of the optical transparency of the component 10 to a desired or preset level is via a wireless connection, for example via a WLAN, and via a corresponding software, in particular with the help of a corresponding app, via which the control device for control or regulation of the optical transparency of the component 10 to a desired or preset level can be accessed. Such wireless control with the help of an app can again be either purely manual or in cooperation with a sensor system (e.g., a photocell or a stray light detector with associated electronics) that measures the light passage through the first space area 14 between the first and the second pane 11, 12 and correspondingly, depending on the desired degree of transparency, in various instances automatically controls the quantity, the location of supply and/or the density of the supplied or discharged fog or fluid.

The frame profile 25 is in various instances a hollow profile, as it is known from window construction. In this hollow profile, the required electrical or fluid lines can be integrated into it or carried through it.

The panes 11, 12, 20 can be formed as rigid glass panes but also as flexible panes or self-supporting transparent films. In particular, they can also be curved, i.e., the component 10 does not have to be flat but can also be half-cylindrically shaped, dome-shaped, hemispherically shaped, etc.

The supply of the component 10 with electrical energy is in various instances carried out by means of a battery or a rechargeable battery. However, it can also be connected to the electrical power supply. Particularly, in various instances, a solar cell is integrated in the component 10 or the electrical connection of the component 10 is integrated with a solar cell to thereby provide the required electrical energy.

1-15. (canceled)

16. A component with changeable optical transparency, said component comprising:
a first optically transparent pane and a second pane, wherein the first pane and the second pane are spaced apart from one another at least in some areas by a space;
a separating device dividing the space into a first space area and a second space area;
an introduction device for introducing one of a fog, a gas or a liquid for changing the passage of light at least through the first space area; and
a means for removing the fog, liquid, or gas at least from the first space area;
wherein the separating device is movable and separates the first space area from the second space area at least substantially in one of a gas-tight, a liquid-tight, or a fog-tight manner.

17. The component of claim 16, wherein the second pane is an optically transparent pane.

18. The component of claim 16 further comprising a sensor system for measuring the passage of light through the first space area between the first and the second pane and, depending on a preset level of transparency, for controlling via a control device at least one of a quantity, a location of introduction, and a density of the fog, liquid or gas introduced.

19. The component of claim 18, wherein control is set up wirelessly and by means of software.

20. The component of claim 16, wherein the component is selected from the group consisting of a window, a glazing element of a window, a glazing element of a conservatory, a door, a glass door, a glazing element of a door, a room divider, a partition wall, a part of a room divider, a part of a partition wall, a shower cubicle, a part of a shower cubicle, an aquarium, a part of an aquarium, a glazing element of a balcony balustrade, a part of a balcony boundary or a light dome.

21. A component with changeable optical transparency, said component comprising:
a first optically transparent pane and a second pane, wherein the first pane and the second pane are spaced apart from one another at least in some areas by a space;
a separating device dividing the space into a first space area and a second space area;
an introduction device for introducing one of a fog, a gas, or a liquid for changing the passage of light at least through the first space area; and
a means for removing the fog, liquid, or gas at least from the first space area;
wherein the separating device is movable within the space so that by a movement of the separating device at least one of the size of the first space area can be changed or the ratio of the size of the first space area to the size of the second space area can be changed, and wherein the separating device comprises one of a rod, a beam or a hollow element.

22. The component of claim 21, wherein the second pane is an optically transparent pane.

23. The component of claim 21 further comprising a sensor system for measuring the passage of light through the first space area between the first and the second pane and, depending on a desired level of transparency, for controlling via a control device at least one of a quantity, a location of introduction, and a density of the fog, liquid or gas introduced.

24. The component of claim 23, wherein control is set up wirelessly and by means of software.

25. The component of claim 21, wherein the component is selected from the group consisting of a window, a glazing element of a window, a glazing element of a conservatory, a door, a glass door, a glazing element of a door, a room divider, a partition wall, a part of a room divider, a part of a partition wall, a shower cubicle, a part of a shower cubicle, an aquarium, a part of an aquarium, a glazing element of a balcony balustrade, a part of a balcony boundary or a light dome.

26. A component with changeable optical transparency, said component comprising:
a first optically transparent pane and a second pane, wherein the first pane and the second pane are spaced apart from one another at least in some areas by a space;
at least one of:
a movable separating device dividing the space into a first space area and a second space area; and
a lighting device for illuminating at least the interior of the first space area;
an introduction device for introducing one of a fog, a gas, or a liquid for changing the passage of light at least through the first space area;
a means for removing the fog, liquid, or gas at least from the first space area; and
at least one of a:
a generating device for a generation of the fog, liquid or gas; and
a storage device for storing the fog, liquid or gas,
wherein the generating device is one of:
arranged within one of the space or the first space area; and
is one of part of the separation device or integrated into separation device, and
where the storage device is one of:
arranged within one of the space or the first space area; and
is one of part of the separation device or integrated in the separation device.

27. The component of claim 26, wherein the second pane is an optically transparent pane.

28. The component of claim 26 further comprising a sensor system for measuring the passage of light through the first space area between the first and the second pane and, depending on a preset level of transparency, for controlling via a control device at least one of a quantity, a location of introduction, and a density of the fog, liquid or gas introduced.

29. The component of claim 28, wherein control is set up wirelessly and by means of software.

30. The component of claim 26, wherein the component is selected from the group consisting of a window, a glazing element of a window, a glazing element of a conservatory, a door, a glass door, a glazing element of a door, a room divider, a partition wall, a part of a room divider, a part of a partition wall, a shower cubicle, a part of a shower cubicle, an aquarium, a part of an aquarium, a glazing element of a balcony balustrade, a part of a balcony boundary or a light dome.

31. A component with changeable optical transparency, said component comprising:
a first, optically transparent pane and a second pane, wherein the first pane and the second pane are spaced apart from one another at least in some areas by a space;
at least one of:
a movable separating device dividing the space into a first space area and a second space area; and
a lighting device for illuminating at least the interior of the first space area;
an introduction device for introducing one of a fog, a gas, or a liquid for changing the passage of light at least through the first space area;
a means for removing the fog, liquid, or gas at least from the first space area; and
a control device for one of automatic or manual control of the optical transparency of the component to a preset level.

32. The component of claim 31, wherein the second pane is an optically transparent pane.

33. The component of claim 31 further a sensor system for measuring the passage of light through the first space area between the first and the second pane and, depending on a preset level of transparency, for controlling via the control device the at least one of a quantity, a location of introduction, and a density of the fog, liquid or gas introduced.

34. The component of claim 33, wherein control is set up wirelessly and by means of software.

35. The component of claim 31, wherein the component is selected from the group consisting of a window, a glazing element of a window, a glazing element of a conservatory, a door, a glass door, a glazing element of a door, a room divider, a partition wall, a part of a room divider, a part of a partition wall, a shower cubicle, a part of a shower cubicle, an aquarium, a part of an aquarium, a glazing element of a balcony balustrade, a part of a balcony boundary or a light dome.
